(19) United States
(12) Patent Application Publication
(10) Pub. No.: US 2013/0158455 A1
(43) Pub. Date: Jun. 20, 2013

(54) Massage Roller

(71) Applicants: Marika Ruschmeyer, Cincinnati, OH (US); Jaime Rossi, Cold Springs, KY (US)

(72) Inventors: Marika Ruschmeyer, Cincinnati, OH (US); Jaime Rossi, Cold Springs, KY (US)

(21) Appl. No.: 13/713,706

(22) Filed: Dec. 13, 2012

Related U.S. Application Data
(60) Provisional application No. 61/576,167, filed on Dec. 15, 2011.

(51) Int. Cl. A61H 15/00

(52) U.S. Cl. CPC A61H 15/00
USPC 601/118

(57) ABSTRACT

A massage device comprising at least one cylinder adjustably mounted on a rod, a sphere at one end and a cap with a planar surface at the other end of the rod. The massage device may be utilized for massage of another or for self-massage. The massage device may be utilized to achieve release of the first rib.

### CROSS-REFERENCE TO RELATED APPLICATIONS

This application claims priority to, and the benefit of U.S. Provisional Patent Application No. 61/576,167, filed on Dec. 15, 2011, which is incorporated herein by reference in its entirety.

### FIELD OF THE INVENTION

The invention relates to massage devices, particularly hand held massage devices.

### BACKGROUND OF THE INVENTION

Massage may provide health and lifestyle benefits to the recipients. Thorough, effective massage is difficult to perform without training, and can be very tiring for the person providing the massage. It is particularly difficult for an untrained person to achieve release of the first rib while providing a massage. For a person providing self-massage, it is extremely difficult to achieve release of the first rib.

### SUMMARY OF THE INVENTION

The device provided herein is useful in massage of another person or of one's self. In an embodiment, the device allows release of the first rib of the massage recipient. In an embodiment, the device allows the massage subject to release the subject's own first rib. In aspects of the device, one or more cylinders of the device fit between muscle fibers, allowing thorough massage of the muscle tissues. In aspects of the device, the adjustable massage roller allows self-massage of the quadriceps, hamstrings, IT-band, buttocks, back, foot and other body regions.

In an embodiment, the application provides a massage device comprising a cylindrical rod with a sphere at one end, a middle section and a cap at the second end. The massage device further comprises at least one cylinder adjustably mounted on the middle section of the rod, wherein the cylinder has an aperture through the cylinder, the rod extends through the cylinder and the cylinder is rotatable about the rod. Each cylinder is axially movable and positionable along the middle section of the rod. The massage device cap comprises a planar surface distal to the middle section of the rod. In an aspect of the device, at least one adjustably mounted cylinder is perpendicular to the rod. In an aspect of the device an adjustably mounted cylinder is solid. In an aspect of the device the length of a cylinder ranges between 0.5 inches and 4 inches. In an aspect of the device, a cylinder fits between muscle fibers. In an aspect of the device the diameter of the cylinder ranges between 0.5 inches and 6 inches. In an aspect of the device, the diameter of an end of the cylinder differs from the diameter of the cylinder center. In an embodiment of the device, at least two cylinders are mounted on the rod. In an embodiment of the device at least three cylinders are mounted on the rod. In an embodiment of the device, the diameter of the sphere is in the range of 2 inches to 5 inches. In an embodiment, the device is a self-massage device. In an embodiment, the sphere is detachable from the rod.

An embodiment provides a massage device and an instructional video.

### BRIEF DESCRIPTION OF THE DRAWINGS

FIG. 1 is a view of the massage device including adjustably mounted, rotatable cylinders 40 on an axial rod 10 with a rib-releasing sphere 20 on one end of the rod 10 and a cap 30 with a planar surface 35 on the other end of the rod 10.

FIG. 2 is a view of the massage device positioned between a massage recipient and a vertical surface for release of the massage recipient's first rib.

FIG. 3 is a view of the massage device including adjustably mounted rotatable cylinders 40 on an axial rod 10 and the rib-releasing sphere 20 detached from the end of the rod 10 and an adjusting tool 60.

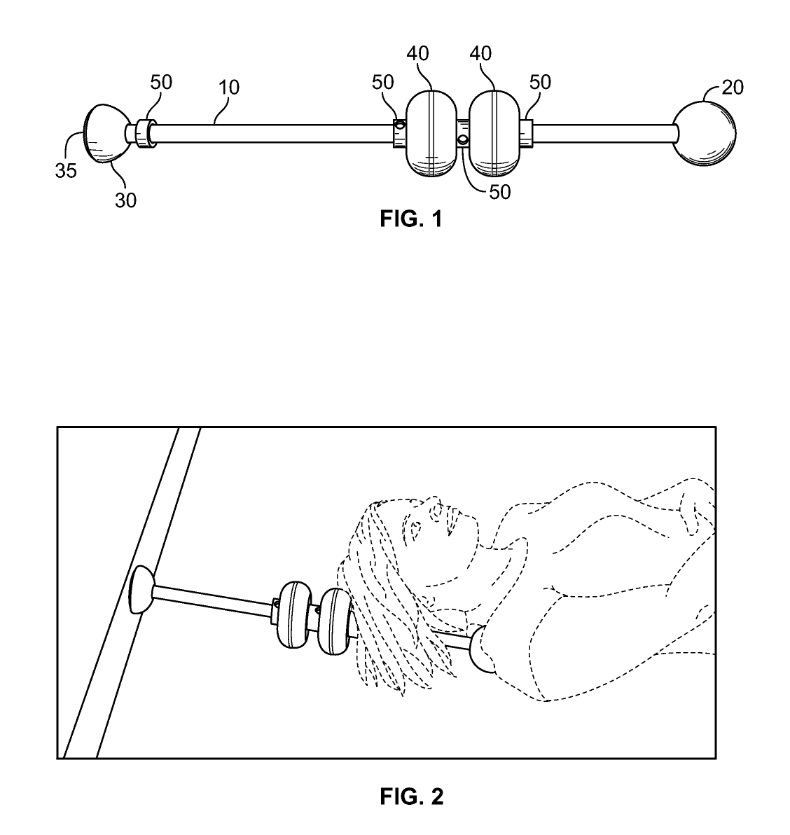

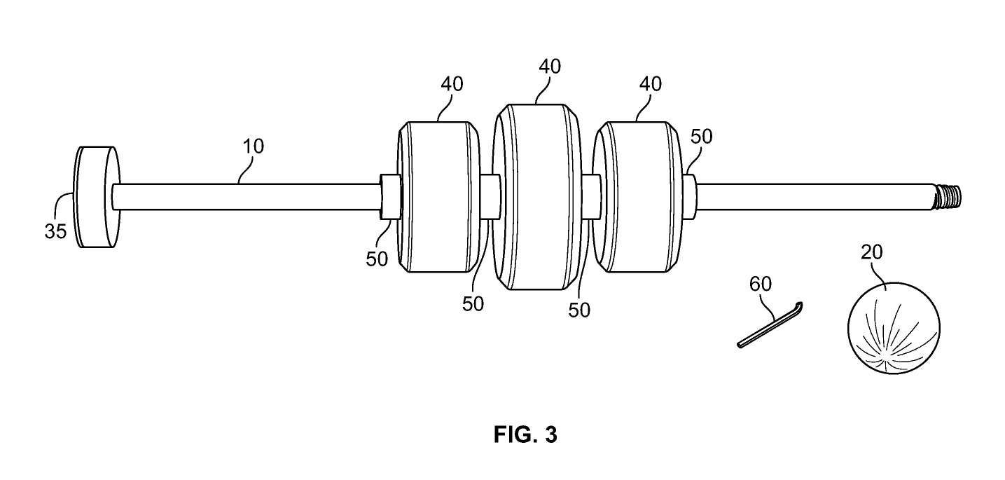

### DETAILED DESCRIPTION OF THE INVENTION

The massage device of the subject application is generally comprised of at least one cylinder adjustably mounted on an axial rod or shaft. Massage encompasses manipulation of a soft tissue including but not limited to, muscle, fascia, tendons, ligaments, and connective tissue of a massage recipient for therapeutic purposes. A therapeutic benefit may include, but is not limited to, a therapeutic benefit selected from the group of benefits comprising relaxation, stretching, realignment, repositioning, release, softening, lengthening, reordering and loosening of a soft tissue of interest. The rod 10, such as a dowel, has a sphere 20 on an outer end, a middle section, and a cap 30 with a planar surface on the end of the rod opposite the sphere. One or more cylinders 40 may be positioned along the middle section of the rod. Each cylinder comprises an aperture through which the rod extends, passes, slides, glides, moves or travels. Each cylinder is axially movable and positionable along the middle section of the rod. The cylinders are axially secured in a temporary manner once the appropriate cylinder position is achieved. The cylinders may be positioned such that one or more is perpendicular to the rod 10.

Cylinders 40 used in compositions of the application may be solid, hollow, filled, fluid filled or gel-filled. Generally cylinders used in the compositions are firm or minimally compressible, by which is intended that a cylinder retains its shape during normal use of the device. Cylinders for use in the compositions may vary in length. When a plurality of cylinders is positioned on a rod, the length of the cylinders may be same or different. The cylinder length may range between 0.5 inches and 6 inches, 0.5 inches and 5.5 inches, 0.5 inch and 5 inches, 1 inch and 5 inches, 1 inch and 4.5 inches, 1 inch and 4 inches, 1 inch and 3.5 inches, 1 inch and 3 inches, 1 inch and 2.5 inches, 1 inch and 2.0 inches, and 0.5 inches and 1.5 inches. In various aspects of the device, the cylinder length may fit between muscle fibers, within a muscle fiber, between different tissue layers, or within a tissue layer to allow therapeutic benefit to soft tissue of interest. Without being limited by mechanism, the cylinders may allow massage of different muscle fibers within a muscle group. Without being limited by mechanism, the cylinders may fit between, separate, or divide muscle fibers to allow therapeutic benefit to a muscle fiber of interest. The cylinder diameter may range between 0.5 and 10 inches, 0.5 and 9.5 inches, 0.5 and 8.5 inches, 0.5 and 6.5 inches, 1 and 9 inches, 1.5 and 8.5 inches, 1.5 and 8 inches, 1.5 and 7.5 inches, 1.5 and 7 inches, 1.5 and 6.5 inches, 1.5 and 6 inches, 1.5 and 5.5 inches, 1.5 and 5 inches, 1.5 and 4.5 inches, 1.5 and 4 inches, 1.5 and 3.5 inches, 1.5 and 3 inches, and 1.5 and 2.5 inches. In an aspect of the claimed device, the number of cylinders positioned on the rod is at least one, two, three, four, five, six, seven, eight, nine, ten or more.

Factors that may impact selection of the number, size and placement of cylinders may include but are not limited to the size of the massage recipient, the region, tissue, or muscle mass that is to be massaged, the size of the region to be massaged, muscle anatomy within the region to be massaged, the amount of tissue damage the area to be massaged has experienced, the type of tissue damage the area to be massaged has experienced, the desired effect of the massage, self-massage versus massage of another, body position of the massage recipient, and body position of the person performing the massage. For example, it is envisioned that cylinder position for massage of the quadriceps may vary from the cylinder position for massage of the lumbar region. The adjustable massage roller allows self-massage of various muscle masses and tissues including but not limited to the quadriceps, hamstrings, trapezius, adductors, erector spinae muscles, rhomboid and back muscles, buttocks, ilio-tibial (IT) band, and linea aspera. Without being limited by example, two smaller same size cylinders separated from each other may be used for separation of the spinous processes and massage of the erector spinae muscles. Without being limited by example, a large center cylinder surrounded by two or more smaller cylinders may be used for self-massage of the hamstrings and adductor/quadriceps attachment. Without being limited by example, a cylinder approximately as long as the width of the massage recipient's ilio-tibial (IT) band may be used for massage of the IT band.

Cylinders 40 utilized in the device are adjustably mounted to the rod. The cylinders are attached, positioned, located, mounted, clamped or placed on the rod. “Adjustably mounted” is intended to indicate the user of the device may reposition, remount, relocate, alter, change, move, slide, shift, change, replace, add, or remove cylinders from the rod. A retaining mechanism 50 maintains the axial positioning of each cylinder until the user releases the retaining mechanism. Retaining mechanisms 50 suitable for use with the device may include, but are not limited to, collar and set-screw mechanisms, clamps and hitch pins, R-clips, universal clamps, C-clips, circlips, snap rings, retaining rings, spacers, and e-clips. In various embodiments the retaining mechanisms may bracket a cylinder, may be longitudinally outset from a cylinder, may bracket multiple cylinders, and may interpose multiple cylinders to limit lateral movement along the rod 10. An adjusting tool 65 such as but not limited to a key, allen wrench, hex wrench, Torx device, wrench or pick may facilitate positioning of a retaining mechanism. In various aspects of the invention, an adjusting tool may be stored within the rod or sphere of the device. Without being limited by mechanism, the adjustable spacing between cylinders may provide penetration to different tissue layers and muscle fibers. In various embodiments, the cylinders 40 may rotate about the rod 10 as the massage device is used. It is recognized that when multiple cylinders are utilized, they may rotate at different rates.

Cylinders 40 utilized in the device comprise an aperture. The aperture, hole, tunnel, tube, or passageway is of sufficient diameter to allow rotation around the middle section of the rod.

A massage device of the instant application comprises a cap 30 with a planar surface 35 at one end of the rod. It is envisioned that the planar surface 35 of the cap 30 is distal to the middle section of the rod. The planar surface of the cap may further comprise an additional layer. Additional layers may include, but are not limited to, coatings, pads, padding, or spacers, particularly such as those which would reduce scratching, scraping, or marring of the vertical surface next to which the device is positioned for release of the first rib.

A massage device of the current application comprises a sphere 20 located at one end of the rod. Generally a sphere, ball, or knob used in the claimed massage device is firm or minimally compressible, by which is intended that the sphere retains its shape during normal use of the device. Sphere diameters for use in the massage device range from 1.5 to 6 inches, particularly in the range of 2 to 5 inches, and more particularly in the range of 2 to 3 inches. In an embodiment, the sphere diameter is approximately 2.5 inches. It is recognized that factors that may impact selection of a sphere size include, but are not limited to, massage recipient size, massage recipient muscle tone, size of massage recipient's upper trapezius and massage recipient body mass index.

The sphere 20 may be removable from the rod 10, may be affixed to the rod 10, or may be molded to the rod 10. The cap 30 with a planar surface may be removable from the rod, may be affixed to the rod or may be molded to the rod. It is envisioned that the sphere and the cap may be removable from the rod, the sphere may be removable and the cap affixed, the cap may be removable and the sphere affixed, and the cap and sphere may be affixed to the rod when the rod is comprised of separable portions.

“First rib release” encompasses relaxation, repositioning, shifting, moving, stretching or altering a muscle fiber in the region around the first rib. In an embodiment, the device allows a person to obtain release of their own first rib. For first rib release, the massage recipient lays on a horizontal surface and positions the massage device between the recipient's shoulder and a vertical support. Vertical supports useful with the claimed massage device include but are not limited to a wall, cabinet, furniture, door, or doorway. The planar surface 35 of the cap is positioned against the vertical support. The sphere 20 on the opposite end of the massage device is positioned against the massage recipient's shoulder. Movement of the recipient's arm in a particular pattern when the massage device is placed for first rib release may allow release of the first rib. It is recognized that release of the first rib may occur after one or more releasing motions. Muscle tightness, muscle rigidity and muscle positioning may affect the number of releasing motions needed to result in first rib release. In an embodiment, the sphere 20 may be detached from the rod 10 for massage of body parts including, but not limited to, a foot, two feet, quadriceps, hamstrings, trapezius, adductors, erector spinae muscles, rhomboid and back muscles, buttocks, ilio-tibial (IT) band, linea aspera, hand, gastrocnemius, soleus, and the plantar fascia.

Claimed kits comprise a video in any format including but not limited to DVD, MPEG, videotape, streaming video, and electronic digital format. The subject matter of the video may include but is not limited to instructional material.

All publications, patents, and patent applications mentioned in the specification are indicative of the level of those skilled in the art to which this invention pertains. All publications, patents, and patent applications are herein incorporated by reference to the same extent as if each individual publication or patent application was specifically and individually incorporated by reference.

Although the foregoing invention has been described in some detail by way of illustration and example for purposes of clarity of understanding, it will be obvious that certain changes and modifications may be practiced within the scope of the appended claims.

That which is claimed:

1. A massage device comprising:
(a) a cylindrical rod with a sphere at one end, a middle section and a cap at the second end;
(b) at least one cylinder adjustably mounted on the middle section of said rod, each cylinder having an aperture through said cylinder, said rod extending through said aperture, wherein said cylinder is rotatable about the rod;
(c) wherein each cylinder is axially movable and positionable along the middle section of the rod; and
(d) wherein said cap comprises a planar surface distal to said middle section.

2. The massage device of claim 1 wherein at least one adjustably mounted cylinder is perpendicular to said rod.

3. The massage device of claim 1 wherein said cylinder is solid.

4. The massage device of claim 1 wherein the length of said cylinder ranges between 0.5 inches and 6 inches.

5. The massage device of claim 1 wherein said cylinder fits between muscle fibers.

6. The massage device of claim 1 wherein the diameter of said cylinder ranges between 0.5 inches and 10 inches.

7. The massage device of claim 6 wherein said diameter ranges between 1 inch and 6 inches.

8. The massage device of claim 7 wherein the diameter of an end of said cylinder differs from the diameter of the center of said cylinder.

9. The massage device of claim 1, comprising at least two cylinders mounted on said rod.

10. The massage device of claim 1, comprising at least 3 cylinders mounted on said rod.

11. The massage device of claim 1 wherein the diameter of said sphere is in the range of 1 inch to 5 inches.

12. The massage device of claim 1 wherein said massage device is a self-massage device.

13. A massage kit comprising a massage device of claim 1 and a video.

14. The massage device of claim 1, wherein said sphere is detachable.
